(19) United States
(12) Patent Application Publication
(10) Pub. No.: US 2021/0241629 A1
(43) Pub. Date: Aug. 5, 2021

(54) AN AIRCRAFT TRAFFIC CONTROL METHOD

(71) Applicant: VINATI S.R.L., Nave (BS) (IT)

(72) Inventors: Felice VINATI, Nave (BS) (IT); Giacomo VINATI, Nave (BS) (IT); Matteo VINATI, Nave (BS) (IT); Mariachiara VINATI, Nave (BS) (IT); Samuele VINATI, Nave (BS) (IT)

(73) Assignee: VINATI S.R.L., Nave (BS) (IT)

(21) Appl. No.: 16/757,805

(22) PCT Filed: Sep. 28, 2018
(86) PCT No.: PCT/IB2018/057538

§ 371 Date: Apr. 21, 2020

(30) Foreign Application Priority Data
Oct. 25, 2017 (IT) 102017000121411

(51) Int. Cl. G08G 5/00; G08G 5/04

(52) U.S. Cl. CPC G08G 5/0013; G08G 5/0021; G08G 5/045; G08G 5/0082; G08G 5/0043

(57) ABSTRACT

An aircraft traffic control method is described which includes receiving data concerning the position of aircrafts, creating a real-time map of aircraft traffic based on the position data; checking the possibility of a collision between aircrafts on the basis of the map, and, in the event that such check is positive, sending an anti-collision alert to the aircrafts. The method is implemented using an RTS server (Real Time Server) configured to communicate with navigational devices on board aircrafts and provided with an application configured to communicate data concerning the position of the aircrafts to the RTS server.

### FIELD OF THE INVENTION

The present invention concerns an aircraft traffic control method.

### TECHNOLOGICAL BACKGROUND OF THE INVENTION

The development of drones and the not very remote hypothesis of flight systems even with automatic pilots that will soon crowd the skies, creates the problem of air navigation control of all these aircraft.

There are many applications for visual flight but all of these limit themselves to proposing the cartography of the areas of overflight and to visualize the route set by the pilot.

There are many applications that allow cars to follow a road route to reach their destination, among them there are some that also offer an additional option: to be able to see all the vehicles near the user using the same application.

For example, there are car traffic applications that not only allows a user to see other vehicles that are using the same application, but also allows the user to be seen as long as he/she has consented to this functionality.

The purpose of this invention is to provide a method and system for the control of aircraft that are not covered by Visual Flight Rules (VFR).

Another purpose of the invention is to make available one of the most important data in the field of flight, namely the presence of other aircraft in the airspace and their navigation data.

### SUMMARY OF THE INVENTION

These and other aims that will be apparent from reading the present description are obtained by virtue of an aircraft traffic control method comprising the following steps:
receiving data concerning the position of the aircrafts;
creating a real-time map of aircraft traffic based on the position data;
checking on the basis of the map the possibility of a collision between aircrafts, and
in the event that such check is positive, sending an anti-collision alert to the aircrafts,
   said method being implemented by means of an RTS server (Real Time Server) configured to communicate with navigational devices onboard of the aircrafts and provided with an application configured to communicate data concerning the position of the aircrafts to the RTS server and to determine the ideal route and ideal level of flight in compliance with Visual Flight Rules (VFR) and the areas of overflight defined by aeronautical mapping, said application being interfaceable with the aircraft flight control system.

An advantage of this embodiment is that it not only allows the aircraft to see and be seen by other aircrafts but also indicates its flight altitude, ground level, speed, course, and estimated time of approach to the aircraft, as well as all data related to or correlated with data concerning the position of the aircraft.

The invention concerns also an aircraft traffic control system, wherein the system comprises a RTS server configured for remote communication with aircraft navigation devices present onboard of the aircrafts and provided with an application, wherein said application is configured to communicate data regarding the position of the aircrafts to the RTS server, and to determine the ideal route and ideal level of flight in compliance with Visual Flight Rules (VFR) and the areas of overflight defined by aeronautical mapping, said application being interfaceable with the aircraft flight control system and wherein the RTS server suitable for receiving aircraft position data for creating a real-time map of aircraft traffic based on position data and for checking based on that map the possibility of collision between the aircrafts, and in the event that such check is positive, for sending an anti-collision alert to the aircrafts.

Additional functionality consists of collision avoidance and flight assistance algorithms including functionality for autorotation or glide landing of the aircraft.

Further characteristics of the invention can be deduced from the dependent claims.

### BRIEF DESCRIPTION OF THE FIGURES

Further characteristics and advantages of the invention will be evident from the reading of the following description provided by way of example and not limited, with the help of the attached figure, in which:

FIG. 1 schematically shows an example of air traffic covering a portion of airspace, where the aircraft involved use the invention method; and

FIG. 2 schematically shows a navigation device on board an aircraft, said device being configured to implement the method according to the invention.

### DETAILED DESCRIPTION OF THE FIGURES

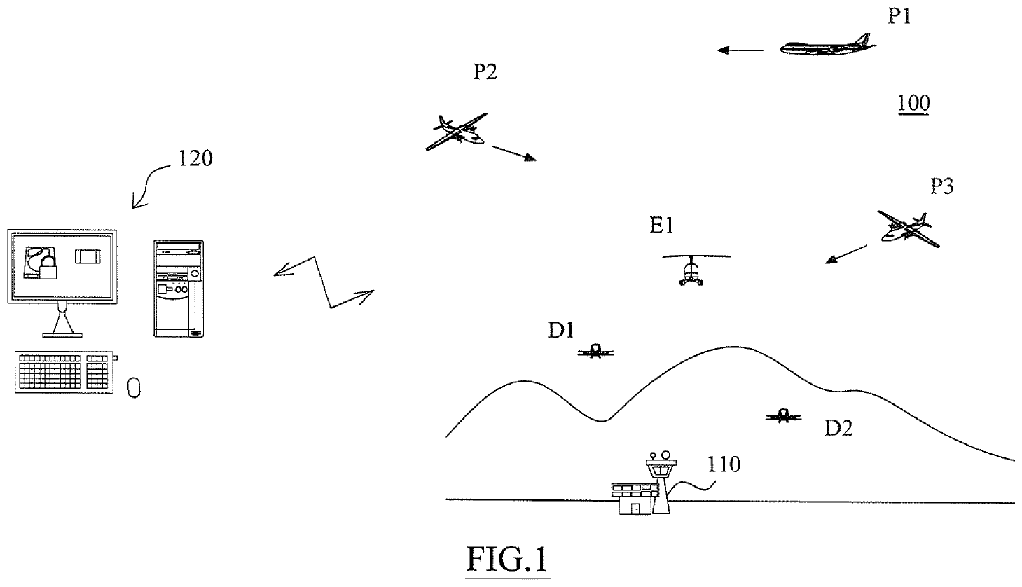

Reference is now made to FIG. 1, which is a schematic illustration of an example of air traffic covering a portion of airspace 100, where the aircraft involved use the method and system of invention.

This method allows the creation of an air traffic mapping service covering a given airspace.

Under the system of invention, each aircraft can transmit its position to an RTS (Real Time Server) 120 server configured to receive position data, in order to create a real-time map of aircraft traffic on the basis of position data.

The example in FIG. 1 shows three aircraft P1, P2 and P3, two drones (without pilot on board) D1, D2 and an E1 helicopter, as well as a control tower 110.

These aircraft have been exemplified to show that the invention system can work both with aircraft, such as planes and helicopters that are commanded by one or two pilots on board, and with auto-guided or remotely-controlled aircraft such as drones.

In addition, the system can operate both with aircrafts, such as planes, which must always be equipped with a forward motion in order to generate the necessary lift, and with aircrafts, such as helicopters or drones, which can also in certain situations maintain a fixed position in airspace for a certain time, or a stationary flight position also called “hovering”.

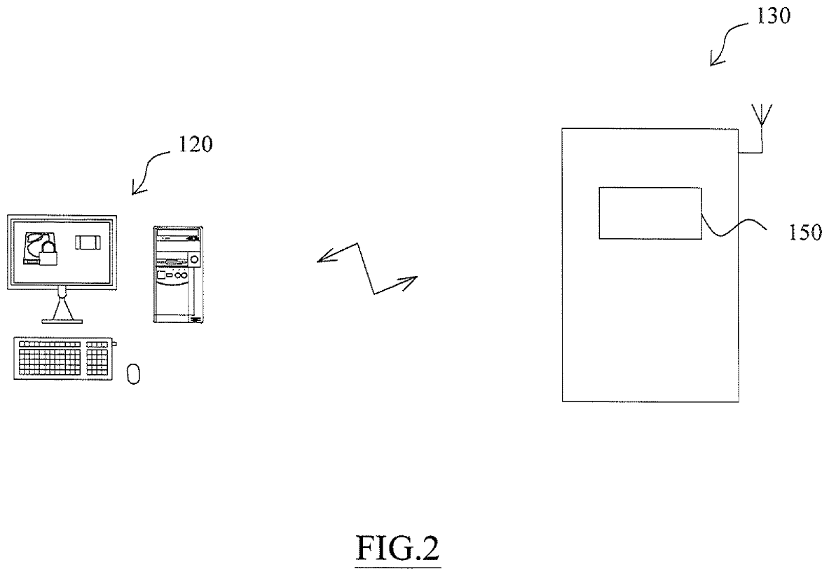

Each P1, P2, P3, D1, D2 and E1 aircraft may have on board its own 130 navigation device (shown for example in FIG. 2) which may communicate with the RTS 120 server and which may run an application covered by this invention.

In turn, the RTS 120 server can receive the position of the aircraft from each aircraft navigation device 130, as well as other data.

For example, the P1 aircraft bbcan be in the position defined by the coordinates (XP1, YP1, ZP1) at a certain time and can transmit its position to the RTS 120 server.

Correspondingly, the RTS 120 server can record the position received by the P1 aircraft and associate it with a timestamp value indicating the time at which the position of the P1 aircraft was recorded.

Successive position readings taken at short time intervals from each other for the same aircraft may allow the RTS 120 server to calculate the speed of the aircraft P1 and its estimated route.

The calculation of the estimated routes for the various aircraft can be performed by the RTS 120 server in combination with a proprietary collision avoidance algorithm, based on the real-time map of aircraft traffic created by the RTS 120 server, in order to verify the regularity of flight operations and to generate alarms if two (or more) aircraft follow routes that could cause them to collide.

The RTS 120 server can then execute processing algorithms that determine the parameters required to control the aircraft in order to avoid possible collision routes involving aircraft in flight in a given airspace 100, as mentioned above, or violation of airspace such as CTR (Control Zone), Pzone (Prohibited zone or prohibited areas) and all those areas provided on aeronautical mapping that the aircraft can not fly or that are subject to special rules of overflight.

Once these checks have been completed, if one or more of them are positive, an anti-collision warning shall be given to the aeroplanes concerned.

In addition to this, the RTS 120 server can make available all the information of the aircraft in flight to application 150, determines and indicates the routes in the vicinity of the aircraft and indicates the alert states in case of non-compatible routes or expected collision hypothesis, simultaneously giving notice to all the aircraft concerned.

In the event of an expected collision, the algorithm generates an alarm signal and provides indications to the aircraft involved of the route and flight level to be followed in order to avoid possible collisions, taking into account all the aircraft in flight in the area concerned.

In order to connect with the RTS 120 server, the application 150 can use 3G, 4G phone connections or other existing protocols for wireless connections.

The application 150 can interface with the GPS system to communicate to the RTS 120 server the GPS data of the positioning of the aircraft and the flight plan.

This application 150 is useful and necessary also in view of the future market of unmanned and unmanned aircraft and above all with reference to Italian patent application no. 102017000108804 of Sep. 28, 2017 which will certainly give a great boost to the development of aeronautical aircraft.

It is also to be hoped that manufacturers of unmanned and unmanned aircraft will have to ensure that flights cannot begin until they have connected to the RTS 120 server with the application 150 that is the object of this invention, thereby ensuring that airspace can be effectively controlled.

The RTS 120 server is, in general, able to manage all the information received by the application 150 such as:
Aeroplane data:
   Typology
   Marks (if any) or aeroplane data
   Flight plan
      Commander
      Number of passengers
      Place of departure or take-off
      Time of Departure or take-Off
      Destination
      Way points
      Flight level
Barometric altitude
Height above ground
Speed detected by the Pitot tube
Calculated speed with positioning data transmitted by the application
Expected approximate speed between aeroplanes
Estimated time of approximation between aircraft
Definition of the collision route
Definition of collision alarms
Definition of alarm levels
Colorful, animated and audible alarm signalling
Definition of an inviolable safety volume around each aircraft (a cube of form and dimensions to be defined)
Transmission of all data to the flight control towers 110 of the various airports also allowing the connection to the RTS 120 server by the airport flight control.

The RTS 110 server can be placed at any remote location.

The pilot of the aircraft instead, on his device 130, once activated the application 150 can see:
2D or 3D cartography
His/her own aircraft is intuitively highlighted
All aircrafts in proximity and according to the chosen map scale
   the route they are following
   the route estimated by the application
   altitude
   ground clearance
   detected speed
   distance in aeronautical miles or Km or other measure
   approach time to his/her aircraft.
   the possible alternative route in the event of a collision.

Application 150 also allows to monitor all flight data.

Another peculiarity of the invention is that application 150 can be interfaced to the aircraft flight control system.

As also mentioned below, the 150 application can allow full control of air navigation in the case of unmanned aircraft. However, there is nothing to prevent this control from being carried out by the application 150 also on a pilot-operated aircraft, in particular situations, for example in the event of an anti-collision alarm or of pilot sickness or otherwise, since the operating principle of the application 150 is always the same.

The invention therefore concretizes a new way of flying that can be defined VIFR (Visual Flight Rules and Instrument Flight), i.e. combining the VFR flight rules with the safety of IFR instrument flight.

The application 150 allows in an innovative way to control also the eventual autorotation of the rotary wing aircraft, providing the data of approximation to the ground to the pilot and alerting him when the distance is optimal to carry out the final flare (or recall) for the landing.

In the case of unmanned aeroplanes the whole procedure is managed by application 150 connected to the flight control system of the aeroplane.

The invention thus allows complete control of the air navigation of unmanned aircraft.

It provides for a number of active functions, namely the possibility of acting on the flight control of the aircraft.

In particular, once the flight plan (place of departure and destination, take-off hours, etc.) is defined by the user or operator of the aircraft, the application 150 determines the ideal route and level of flight in compliance with VFR (Visual Flight Rules) flight rules and areas of overflight defined by aeronautical mapping.

In case of collision alert, application 150 varies route and flight level for the unmanned aircraft to prevent the probable event.

It also provides assistance and air navigation control of pilot aircraft.

Once the flight plan has been defined by the pilot (place of departure and destination, take-off time, etc.), application 150 determines the flight plan with ideal route and flight level in compliance with the VFR (Visual flight rules) flight rules and with the overflight areas defined by the aeronautical cartography.

In the event of a collision alarm, application 150 tells the pilot the new route and flight level to prevent the probable event.

Another advantage of the invention is that it eliminates the need to install transponders on the aircrafts, whether they are drones or pilot aircraft.

The application 150 can communicate messages and data about the flight and aircraft data to the proper control towers if required and/or allowed.

The application 150 is the only system capable of controlling drones air navigation so that it does not interfere with the air navigation of pilot aircraft.

The application 150 becomes a control tower for the pilot himself and its algorithms on the RTS 120 server become flight controllers with the ability to modify active flight management for drones and with the ability to assist and control the flight and anti-collision for aircraft with pilot.

Modifications or improvements to the invention described above may be made for contingent or particular reasons, without however going beyond the scope of the invention as claimed below.

1. An aircraft traffic control method comprising:
receiving data concerning the position of aircrafts;
creating a real-time map of aircraft traffic based on the position data;
checking the possibility of a collision between aircrafts on the basis of the map, and
in the event that such check is positive, sending an anti-collision alert to the aircrafts,
said method being implemented by means of an RTS server (Real Time Server) configured to communicate with navigational devices on board the aircrafts and provided with an application configured to communicate data concerning the position of the aircrafts to the RTS server and to determine the ideal route and ideal level of flight in compliance with Visual Flight Rules (VFR) and the areas of overflight defined by aeronautical mapping, said application being interfaceable with the aircraft flight control system.

2. The method of claim 1, wherein the RTS server may execute processing algorithms that determine the parameters required for aircraft control in order to avoid unlawful violations of controlled airspaces or of airspaces subject to particular flight regulations.

3. The method of claim 1, wherein the RTS server may provide information about aircrafts flying inside an airspace to the application operating on the navigational devices on board the aircrafts flying in said airspace to indicate routes followed by aircraft and alarm states in the case of incompatible routes or foreseen collision in order to alert all affected aircrafts.

4. The method of claim 1, wherein the application operating on a navigation device of an aircraft can be interfaced with a GPS system to communicate to the RTS server the GPS positioning data of the aircraft and the flight plan.

5. The method of claim 1, wherein the application operating on a navigation device of an aircraft may define an inviolable security volume around the aircraft itself.

6. The method of claim 1, wherein the RTS server may transmit data to flight control towers of the various airports and may allow connection to the RTS server by the airport flight control system.

7. The method of claim 1, wherein the application operating on a navigation device of an aircraft can be interfaced with the flight control system of the aircraft.

8. The method of claim 7, wherein the application operating on a navigational device of a rotating wing aircraft can control the autorotation of the rotating wing aircraft by providing ground approximation data and an alert when the distance is optimal to make the final landing flare.

9. An aircraft traffic control system, wherein the system comprises a RTS server configured for remote communication with aircraft navigation devices present on board the aircrafts and provided with an application, wherein said application is configured to communicate data regarding the position of the aircrafts to the RTS server, and to determine the ideal route and ideal level of flight in compliance with Visual flight rules (VFR) and the areas of overflight defined by aeronautical mapping, said application being interfaceable with the aircraft flight control system and wherein the RTS server suitable for receiving aircraft position data for creating a real-time map of aircraft traffic based on position data and for checking based on that map the possibility of collision between the aircrafts, and in the event that such check is positive, for sending an anti-collision alert to the aircrafts.
